(19) United States
(12) Patent Application Publication
(10) Pub. No.: US 2019/0335935 A1
(43) Pub. Date: Nov. 7, 2019

(54) Nonwoven Filter Fabric Composition And Method of Use

(71) Applicants: Matthew Bushman, Riverside, CA (US); Joey Ruiz, Riverside, CA (US)

(72) Inventors: Matthew Bushman, Riverside, CA (US); Joey Ruiz, Riverside, CA (US)

(21) Appl. No.: 15/967,952

(22) Filed: May 1, 2018

(51) Int. Cl. A47J 31/06; A23F 5/26; B01D 39/18; B01D 39/16; B65D 85/808

(52) U.S. Cl. CPC A47J 31/06; A23F 5/262; B01D 39/18; B01D 2239/064; B65D 85/808; B01D 2239/0636; B01D 39/1623

(57) ABSTRACT

A nonwoven filter fabric composition may comprise a blend of at least one thermoplastic and at least one naturally-derived fiber. In some embodiments, a method of using a nonwoven filter fabric composition made according to at least one composition disclosed herein may comprise providing a first filter fabric, configuring the first filter fabric, applying one or more reinforced seams to the first filter fabric thereby creating a first filter bag, inserting one or more substances suitable for steeping into first filter bag, and steeping the first filter bag in a liquid. In some embodiments, the method may comprise steeping the first filter bag in a cold brew system.

### GOVERNMENT CONTRACT

Not applicable.

### CROSS-REFERENCE TO RELATED APPLICATIONS

Not applicable

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to beverage filter fabrics and, more particularly, to a nonwoven filter fabric composition and method of using the same.

### BACKGROUND

As is generally known in the art, many different filters, and related manufacturing processes to produce filters, can be used for steeping, filtering, or treating beverages. Examples include traditional basket filters, filters for use with immersion steeping systems, and single-use filters. Most filters are crafted from a composition of materials. Accordingly, the compositions comprising these filters are known to vary as well.

Filters can be single-use or reusable. Single-use filters can be classified as either woven or nonwoven filters. Woven fabrics and filters are generally produced by weaving the elements together. By contrast, nonwoven filters and nonwoven filter fabrics are, generally, formed by bonding together staple fibers and long fibers via processes other than weaving, such as for example by chemical, mechanical, or thermal processes.

When used for filtration, nonwoven filter fabrics offer several advantages. For instance, while woven mesh filters tend to have particularly strong extraction properties, nonwoven filters are suitable for finely ground ingredients such as tea or coffee. As well, nonwoven filters generally cost less to produce than woven filters. Moreover, some nonwoven filters are recyclable, making them an ecological choice for single-use applications. As may be expected, the composition of materials comprising the nonwoven filter fabric generally determines many if not all of the nonwoven filter fabric's steeping properties.

Generally, the primary ways users filter coffee, tea, spices, herbs, hops, nut milks and any other foods mixed with water is by filters having compositions incorporating paper, plastic mesh, metal mesh, or cloth. Unfortunately, many persons find that using known filtering bags or papers known in the art can be a difficult and inefficient process. For example, many of these filters are fragile, delicate, tear easily, affect taste and are difficult to clean and can break. Others, such as cloth filters, are known to negatively affect the taste of a beverage in which they were used for steeping. Some allow fine particles to pass through and are difficult to clean. And, reusable filters known presently in the art allow fine particles to pass through them, clog easily, are difficult to wash, time-intensive to clean, and laborious to unclog.

What is needed therefore is a durable, nonwoven filter made from a blend of plastics and natural materials that provides strength, filtration and absorption and prevents fine particles from passing through the filter. More specifically, such a filter should be disposable.

Attempts to enhance the filtration or other properties of single-use filters have been made. One effort can be seen with respect to U.S. Patent Application Publication No. 2017/0001759, incorporated by reference in its entirety herein, which generally discloses a multi-chamber package suitable for steeping elements in fluids, wherein one chamber is impermeable and contains loose leaf tea, another chamber is empty and has a permeable mesh wall, and a divider between the chambers, wherein the user may remove the divider when the user wishes to steep the tea. While this disclosure does provide a single-use solution for keeping loose leaf tea unexposed to air and therefore fresh until the user wishes to steep the tea, this disclosure fails to adequately provide for a nonwoven fabric filter on one or more sides of the product.

Another example may be seen with respect to U.S. Patent Application Publication No. 2017/0016157, incorporated by reference in its entirety herein, which generally discloses a nonwoven fabric sheet, a nonwoven extraction filter, and a nonwoven extraction bag. While this disclosure does provide for nonwoven steeping options it fails to provide for a square bag having three reinforced sides and an open fourth side. This shortcoming limits both the functionality of this disclosure and its efficacy for certain applications.

Yet another example may be seen with respect to U.S. Patent Application Publication No. 2016/0200502, incorporated by reference in its entirety herein, which generally discloses a filter bag having an impermeable coating or sealant on the bag that dissolves upon exposure to a solvent, such as hot water. While this disclosure does provide for a well-sealed product, which therefore keeps its contents fresh, the sealant of this disclosure can add chemicals to the user's beverage.

Still, none of these in existence comprise beneficial characteristics described in the following disclosure. Thus, there remains a need for a nonwoven filter fabric composition and method of use that provides for enhanced filtration and infusion of finely ground elements.

### SUMMARY

The present disclosure is directed to a nonwoven filter fabric composition and method of using the same that may provide for enhanced tea and coffee steeping, in addition to other properties.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

The nonwoven filter fabric composition comprises two or more elements combined according to one or more methods or techniques to provide a nonwoven filter bag. The composition of the nonwoven filter fabric (at times “nonwoven filter,” “nonwoven fabric,” “filter,” or “fabric” herein) may, in some embodiments, comprise a blend of plastics and natural materials. In some embodiments, the composition may comprise a blend of one or more synthetic, semi-synthetic, or natural elements or materials. In some embodiments, the present invention may comprise at least one naturally-derived fiber and at least one thermoplastic. “Naturally-derived fiber” as used herein is intended to encompass semi-synthetic fibers or materials, as well as fibers comprised entirely or substantially entirely of naturally-derived source material.

The present invention may also provide for a nonwoven filter bag comprised of a nonwoven filter fabric and one or more additional elements, wherein the nonwoven filter fabric is comprised of one or more fabrics made according to at least one nonwoven filter fabric composition disclosed herein. The dimensions, size and shape of the nonwoven filter bag, in some embodiments, may vary to better suit a variety of containers or quantities of material to be filtered, such as but not limited to coffee, tea, spices, herbs, hops, nut milk or other substances. The present invention may be configured to steep any of these materials or others in a fluid, such as by way of example and not limitation, hot, cold, or lukewarm water or milk.

The nonwoven filter bag, in some embodiments, may be sealed on two or more sides by reinforced seams. In some embodiments, the nonwoven filter may be sealed on three sides by reinforced seams. In some embodiments, the nonwoven filter may be sealed on four sides by reinforced seams. In some embodiments, the present invention may further comprise a closure element. It is contemplated that the piece of filter fabric may have at least one edge and at least a first side and a second side. When folded over on itself, the first side may face itself and the second side may face outward, and the filter fabric may have a folded edge. When a reinforced seam is applied to the folded embodiment of the filter fabric, it may be applied in such a way as to fasten one side of the filter fabric to itself such that the filter fabric forms a bag. The reinforced seam may be configured to transverse, that is cross through, both sides of the filter fabric in such embodiments. In some embodiments, one, two, or three or more reinforced seams may be applied to the filter fabric. In some embodiments, a first piece of filter fabric may be laid across a second piece of filter fabric and one or more reinforced seams may be applied such that the reinforced seam(s) transverse both pieces of filter fabric and create a filter bag or sack. In one or more embodiments, the resulting filter bag or sack made from one or more pieces of filter fabric made from one or more compositions disclosed herein may be shaped as a pocket, a sack, a bag, a pyramid, a sphere, a cube, or any other shape. In some embodiments, the one or more filter bags or sacks made according to at least one composition disclosed herein may have zero, one, or more than one opening.

In an illustrative embodiment, a single sheet of nonwoven filter fabric may be procured, then cut into two rectangle shapes of specified dimensions. Each rectangle of nonwoven filter fabric may then be folded over on itself and sealed on three sides with reinforced seams. This configuration results in a square-shaped pocket made from the nonwoven filter fabric that is sealed on three sides by the reinforced seams and has an opening on the fourth side.

In an additional illustrative embodiment, a single sheet of nonwoven filter fabric may be procured, then cut into two rectangle shapes of specified dimensions. Each rectangle of nonwoven filter fabric may then be folded over on itself and sealed on two sides with reinforced seams. This configuration results in a square-shaped pocket made from the nonwoven filter fabric that is sealed on two sides by the reinforced seams, uses the folded-over portion of the fabric as the third side, and has an opening on the fourth side. This configuration differs from the illustrative embodiment described above in that, at least, the properties of the fabric may cause the third side to be curved, to bulge, to be flexible, and to enable filtration along the curved portion of fabric.

In both illustrative embodiments, and in other embodiments, the resulting present invention comprises a non-woven filter bag, closed on three sides and open on the fourth side. In some embodiments, the cutting, folding and sealing may be accomplished manually. In some embodiments, the cutting, folding and sealing may be accomplished via a mechanical process. In some embodiments, the cutting, folding and sealing may be accomplished via a specialized mechanical process.

Many different types and blends of plastics and naturally-derived materials are contemplated. The different blends of plastics, such as thermoplastics, and natural materials may provide varying levels of strength, filtration and absorption.

The present invention is contemplated to provide one or more benefits. In some embodiments, the nonwoven filter fabric or bag may be durable and disposable, and may not affect the taste of the coffee, tea, spices, herbs, hops, nut milk or other element within the filter. The nonwoven filter may also provide a very fine mesh or straining surface that traps fine particles, such as those associated with coffee, tea, spices, herbs, hops, nut milk or other elements, within the filter. The seams may, among other benefits, add to the durability of the filter and ensure complete filtration.

To use the present invention, the nonwoven filter bag may be created by configuring a piece of nonwoven filter fabric per either of the disclosed methods described above or by another method. For purposes of the present illustrative example, the resulting nonwoven filter bag may be closed on three sides and open on the fourth side. Via the open fourth side, a user may fill the nonwoven filter bag with substance suitable for steeping such as coffee, tea, nuts, spices, herbs, hops or other foods. The, the user may secure the fourth side of the now-filled nonwoven filter bag with a securing element and immerse the now-filled nonwoven filter bag (either partially or entirely, generally entirely) in a container filled with a liquid. In various embodiments, the liquid may be water or milk of any temperature, including but not limited to cold, lukewarm, or hot water or milk. After a period of time, heat, agitation or other parameter, the now-filled nonwoven filter bag may be removed from the container and disposed of, preferably by a recycling method. The user may then enjoy the resulting beverage.

Furthermore, in some embodiments, in addition to substances such as coffee, tea, spices, herbs, hops, nut milk or other materials, it is contemplated that the present invention may be used to filter other foods not identified herein, non-food items, non-water liquids, or even in some embodiments gases. The present invention is also contemplated to be configured, in some embodiments, to be immersed in liquids other than cold water or hot water, such as but not limited to hot milk, cold water, cold milk, beer, wine, broth, stew, or any other mixture. The present invention may also be configured to be immersed either partially or completely in a thick liquid or a gelatinous substance such as mayonnaise or motor oil. In some embodiments, it is contemplated that the present invention may be configured for use within a slurry, such as an ice and water mixture. In some embodiments, it is contemplated that the present invention may be configured for use within a solid, such as ice.

One or more of the above-disclosed embodiments, in addition to certain alternatives, are provided in further detail below with reference to the attached figures. The disclosed subject matter is not, however, limited to any particular embodiment disclosed.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

The nonwoven filter fabric composition of the present invention may comprise a first material, a second material, a third material. In some embodiments, the nonwoven filter fabric composition may further comprise a fourth or more material. The first material, second material, third material, and fourth or more material may be comprised of at least one plastic, such as but not limited to at least one thermoplastic. The first material, second material, third material, and fourth or more material may be comprised of at least one naturally-derived fibers or materials, synthetic fibers or materials, and semi-synthetic fibers or materials. In some embodiments, one or more of the first material, second material, third material, and/or fourth or more material may be comprised of more than one or a combination of naturally-derived fibers or materials, synthetic fibers or materials, and semi-synthetic fibers or materials.

A naturally-derived fiber may be any fiber wherein the majority of the fiber came from one or more natural sources. In some embodiments, a naturally-derived fiber may be comprised entirely or substantially entirely of an element found in nature, such as by way of illustration and not limitation, untreated cotton. In some embodiments, a naturally derived fiber may comprise a chemically-treated natural fiber that was harvested as a natural source material and has been chemically altered.

Non-limiting examples of the natural fibers or natural source materials used to comprise one or more naturally-derived fibers include such materials as flax, hemp, cotton, abaca, jute, white jute, seacell/seaweed, bamboo, kenaf, coir, sisal, wheat, corn, corn starch, sunflower, silk, sugarcane, soybean, wool, ramie, other plants of the boehmeria genus, kapok tree, palm trees, cellulose, cassava roots, cassava chips, cassava starch, natural viscose fibers, and any other plant or natural fiber capable of use as a paper or filtering agent, or as providing cellulose for regenerated cellulose-based fibers. Other woods and papers, such as Kraft paper, are also contemplated.

The nonwoven filter fabric composition of the present invention may also be comprised in whole or in part of any synthetic fibers or materials such as plastics or thermoplastics. Example plastics and thermoplastics include polyethylene (PE), high density polyethylene (HDPE), polyvinyl chloride (PVC), low density polyethylene (LDPE), polypropylene (PP), polystyrene (PS), polyurethane (PU), polyolefin, polyethylene isophthalate, high impact polystyrene (HIPS), acrylonitrile butadiene styrene (ABS), polyamide (nylon), or any synthetic or semi-synthetic plastic, thermoplastic, thermosetting polymer, or bioplastic.

Additional examples of plastics and thermoplastics include but are not limited to polyester, polyester-based resin, linear polyester, copolymerized polyesters, or other type of polyester. For example, in some embodiments, the polyester of the present invention may comprise polyethylene terephthalate (PET or PETE), polyglycolide or polyglycolic acid (PGA), polylactic acid (PLA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate) (PHBV), polytrimethylene terephthalate (PTT), polybutylene terephthalate (PBT), polyethylene naphthalate (PEN), Vectran, polycaprolactone diol (PCL), polyethylene adipate diol (PEA), or other type of polyester.

Naturally-derived fibers such as semi-synthetic fibers or materials may also comprise the nonwoven filter fabric composition of the present invention in part or in whole. Non-limiting examples of semi-synthetic fibers include cellulose regenerated fibers such as rayon, modal, bamboo fiber, semi-synthetic viscose fibers, cellulose acetate, cellulose diacetate, cellulose triacetate, and any other semi-synthetic fiber known in the art.

In some embodiments, the nonwoven filter fabric composition of the present invention may be comprised in whole or in part of a biodegradable materials such as but not limited to a bioplastic such as polylactic acid (PLA) or a biodegradable film or sheet material, which in some embodiments may be plant-based. By way of illustration and not limitation, the biodegradable material may be comprised of degradable polyethylene, biodegradable polyester amide, starch-based polymers, cellulose derivatives and polypeptides, naturally-occurring polyesters, specialty tree-based materials, other forms of biodegradable cellulose-based material, and other types of biodegradable polylactic acid-containing material. In some embodiments, the biodegradable material used for one or more elements of the nonwoven filter fabric composition of the present invention may be coated in an egg-based coating, paraffin spray, corn-based or soy-based substances, or beeswax to improve barrier resistance to oxygen and other atmospheric elements. In some embodiments, the coating may comprise in polyvinylidone chloride (PvdC), polyglycolic acid (PGA).

In some embodiments, the nonwoven filter fabric composition of the present invention may comprise first material and a second material. The first material may be a naturally-derived fiber and the second material may be a thermoplastic. In other embodiments, both the first material and the second material may be a natural-derived fiber. In some embodiments, more than two materials may comprise the nonwoven filter fabric composition. In embodiments having more than three materials, any or all of the materials may comprise a naturally-derived material, a plastic, a thermoplastic, a bioplastic, or any combination of any material or substance disclosed herein.

In some embodiments, the nonwoven filter fabric composition of the present invention may comprise 60% first material, 30% second material, and 10% third material. Relatedly, in some embodiments, the nonwoven filter fabric composition of the present invention may comprise 70% first material, 20% second material, and 10% third material. Moreover, in some embodiments, the nonwoven filter fabric composition of the present invention may comprise 65% first material, 25% second material, and 10% third material. As well, in some embodiments, the nonwoven filter fabric composition of the present invention may comprise 64% first material, 24% second material, 8% third material, and 4% fourth material. Or, in some embodiments, the nonwoven filter fabric composition of the present invention may comprise 64% first material, 28% second material, and 8% third material. In some embodiments, the nonwoven filter fabric composition of the present invention may comprise 68% first material, 24% second material, and 8% third material. Additionally, in some embodiments, the nonwoven filter fabric composition of the present invention may comprise 64% first material, 24% second material, and 12% third material.

In some embodiments, the first material may comprise a plastic, the second material may also comprise a plastic, and the third material may comprise a semi-synthetic fiber. By way of illustration and not limitation, in some embodiments, the nonwoven filter fabric composition of the present invention may comprise 65% first plastic, 25% second plastic, and 10% third semi-synthetic fiber. As well, in some embodiments, the nonwoven filter fabric composition of the present invention may comprise 64% first plastic, 24% second plastic, 8% semi-synthetic fiber, and 4% naturally-derived fiber. Or, in some embodiments, the nonwoven filter fabric composition of the present invention may comprise 64% first plastic, 28% second plastic, and 8% semi-synthetic fiber. In some embodiments, the nonwoven filter fabric composition of the present invention may comprise 68% first plastic, 24% second plastic, and 8% semi-synthetic fiber. Additionally, in some embodiments, the nonwoven filter fabric composition of the present invention may comprise 64% first plastic, 24% second plastic, and 12% semi-synthetic fiber.

Moreover, in some embodiments, the first material may comprise polypropylene, the second material may comprise a polyester, and the third material may comprise viscose fiber. By way of illustration and not limitation, in some embodiments, the nonwoven filter fabric composition of the present invention may comprise 65% polypropylene, 25% polyester, and 10% viscose fiber. As well, in some embodiments, the nonwoven filter fabric composition of the present invention may comprise 64% polypropylene, 24% polyester, 8% viscose fiber, and 4% naturally-derived fiber. Or, in some embodiments, the nonwoven filter fabric composition of the present invention may comprise 64% polypropylene, 28% polyester, and 8% viscose fiber. In some embodiments, the nonwoven filter fabric composition of the present invention may comprise 68% polypropylene, 24% polyester, and 8% viscose fiber. Additionally, in some embodiments, the nonwoven filter fabric composition of the present invention may comprise 64% polypropylene, 24% polyester, and 12% viscose fiber.

Additionally, in some embodiments, the first material may comprise polypropylene, the second material may comprise polyethylene terephthalate, and the third material may comprise viscose fiber. By way of illustration and not limitation, in some embodiments, the nonwoven filter fabric composition of the present invention may comprise 65% polypropylene, 25% polyethylene terephthalate, and 10% viscose fiber. As well, in some embodiments, the nonwoven filter fabric composition of the present invention may comprise 64% polypropylene, 24% polyethylene terephthalate, 8% viscose fiber, and 4% naturally-derived fiber. Or, in some embodiments, the nonwoven filter fabric composition of the present invention may comprise 64% polypropylene, 28% polyethylene terephthalate, and 8% viscose fiber. In some embodiments, the nonwoven filter fabric composition of the present invention may comprise 68% polypropylene, 24% polyethylene terephthalate, and 8% viscose fiber. Additionally, in some embodiments, the nonwoven filter fabric may comprise 64% polypropylene, 24% polyethylene terephthalate, and 12% viscose fiber.

In other or various embodiments, the nonwoven filter fabric composition of the present invention may comprise 1%-99% plastic(s) and 1%-99% natural material(s). By way of illustration and not limitation, in an embodiment, the nonwoven filter fabric composition of the present invention may comprise 25% plastic(s) and 75% natural material(s). Or, an example embodiment of the nonwoven filter fabric composition of the present invention may comprise 40% plastic(s) and 60% natural material(s). In some embodiments, the nonwoven filter fabric composition of the present invention may be comprised of 60% plastic(s) and 40% natural material(s). In yet another example embodiment, the nonwoven filter fabric composition of the present invention may be comprised of 75% plastic(s) and 25% natural material(s).

A nonwoven filter bag made in accordance with at least one embodiment of the nonwoven filter fabric composition of the present invention (hereinafter, a “nonwoven filter bag”) may be comprised of two pieces of nonwoven filter fabric having a first reinforced seam, a second reinforced seam, and an opening. In some embodiments, the nonwoven filter bag may be comprised of a single piece of nonwoven filter fabric having a first reinforced seam, a second reinforced seam, a third reinforced seam, and an opening.

Although generally anticipated in some embodiments to be configured as a flat, square-shaped bag, a nonwoven filter bag made in accordance with at least one embodiment of the nonwoven filter fabric composition of the present invention may be of any shape known in the art, including pyramidal, sack-shaped, multi-layered, spherical, or any other shape. In some embodiments, one or more sides of the nonwoven filter bag may be longer than one or more other sides of the nonwoven filter bag. In such embodiments, one or more sides of the nonwoven filter bag that bound or surround the opening may be longer or shorter than one or more other sides of the nonwoven filter bag that bound or surround the opening.

The first reinforced seam may, in some embodiments, comprise a permanent or temporary joining of two or more elements of the nonwoven filter fabric accomplished by hand, mechanical, chemical, thermal and/or other means, techniques or processes. In some embodiments, the first reinforced seam may comprise a permanent or temporary joining of two or more separate and otherwise unconnected elements of the nonwoven filter fabric by hand, mechanical, chemical, thermal and/or other means, techniques or processes.

Illustrative and non-binding examples of such hand, mechanical, chemical, thermal and other means, techniques or processes include but are not limited to manufacturing processed such as but not limited to interlocking the materials via needlework, by interlocking the materials via adhesives, or by four-step staple nonwoven processes, melt-blown techniques, spunlaid and spunbond processes, flashspun techniques and/or air-laid processes. Additionally, the materials may be bonded via thermal bonding, hydro-entanglement (spunlace), ultrasonic pattern bundong, needle punching and felting, chemical bonding (wetlaid processes), melt-blown bonding, and any other bonding or binding techniques or processes known in the art.

Likewise, in some embodiments, the second reinforced seam may comprise a permanent or temporary joining of two or more sides of a single piece of the nonwoven filter fabric by hand, mechanical, chemical, thermal and/or other means, techniques or processes. In such embodiments, the folding of the single piece of the nonwoven filter fabric may be accomplished by hand, mechanical, chemical, thermal and/or other means, techniques or processes.

Similarly, in some embodiments, the third reinforced seam may comprise a permanent or temporary joining of two or more sides of a single piece of nonwoven filter fabric by hand, mechanical, chemical, thermal and/or other means, techniques or processes. In such embodiments, the folding of the single piece of the nonwoven filter fabric may be accomplished by hand, mechanical, chemical, thermal and/or other means, techniques or processes.

In some embodiments, such as the flat square embodiment discussed herein, the opening may extend fully from side to side of the nonwoven filter bag. However, in some embodiments, the opening may be narrower or shaped differently than in the flat square embodiment. For example, in some embodiments, the general shape of the nonwoven filter bag may be pyramidal, and the opening may be narrower or smaller in size than one or more sides of the nonwoven filter bag. Conversely, would the nonwoven filter bag to be hourglass shaped, the opening may be wider than the middle portion of the nonwoven filter bag. In some embodiments, the sides of the nonwoven filter bag that surround the opening may be of unequal proportions, making the sides of the opening unequal as well.

Relatedly, in some embodiments the opening may be secured with a closure device (not shown) such as but not limited to a string, cable ties, zip-close string assembly, one or more clamps, or any other closure device known in the art.

In another embodiment of the nonwoven filter bag, the nonwoven filter bag may comprise a single piece of nonwoven filter fabric having a first reinforced seam, a second reinforced seam, a folded edge, and an opening.

The folded edge is generally contemplated to comprise one side of the nonwoven filter bag resulting from folding the single piece of nonwoven filter fabric back over itself and applying a first reinforced seam and a second reinforced seam to the piece of nonwoven filter fabric. Although likely relatively flat in some embodiments, the folded edge can be arcuate or creased to any degree or amount. As well, in some embodiments, one or more partial seams may transverse the folded edge. In such embodiments, the remaining un-seamed portions of the folded edge may serve to provide flexibility or additional filtering properties to the nonwoven filter bag.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### EXAMPLES OF PREFERRED EMBODIMENTS

The following examples are given in order to more fully teach what the Applicant regards as the invention. It should be understood that the compositions set forth in the Examples are not to be construed as limiting the scope of the invention, except so far as they yield a nonwoven filter fabric having the desired properties and characteristics.

The following compositions are examples of Applicant's invention with the percentages given by weight:

### Example 1

| | Percent. | Percent. | Percent. | Percent. | Percent. |
|---|---|---|---|---|---|
| | Comp. | Comp. | Comp. | Comp. | Comp. |
| Material | A | B | C | D | E |
| polypropylene | 55 | 60 | 65 | 68 | 64 |
| polyester | 20 | 30 | 25 | 24 | 24 |
| viscose fiber | 25 | 10 | 10 | 8 | 8 |
| natural fiber | 0 | 0 | 0 | 0 | 4 |

### Example 2

| | Percent. | Percent. | Percent. | Percent. | Percent. |
|---|---|---|---|---|---|
| | Comp. | Comp. | Comp. | Comp. | Comp. |
| Material | A | B | C | D | E |
| polypropylene | 55 | 60 | 65 | 68 | 64 |
| polyethylene | | | | | |
| terephthalate | 20 | 30 | 25 | 24 | 24 |
| viscose fiber | 25 | 10 | 10 | 8 | 8 |
| natural fiber | 0 | 0 | 0 | 0 | 4 |

### Example 3

| | Percent. | Percent. | Percent. | Percent. | Percent. |
|---|---|---|---|---|---|
| | Comp. | Comp. | Comp. | Comp. | Comp. |
| Material | A | B | C | D | E |
| polypropylene | 55 | 60 | 65 | 68 | 64 |
| polyethylene | | | | | |
| terephthalate | 20 | 30 | 25 | 24 | 24 |
| viscose fiber | 25 | 10 | 10 | 8 | 8 |
| other polyester | 0 | 0 | 0 | 0 | 4 |

### CONCLUSIONS, RAMIFICATIONS, AND SCOPE

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly define such terms. Accordingly, the actual scope encompasses not only the disclosed embodiments, but also all equivalent ways of practicing or implementing the disclosed present invention. The above description of embodiments of the present invention is not intended to be exhaustive or limited to the precise form disclosed above or to a particular field of usage.

While specific embodiments of, and examples for, the present invention are described above for illustrative purposes, various equivalent modifications are possible for which those skilled in the relevant art will recognize.

While certain aspects of the present invention are presented below in particular claim forms, various aspects of the present invention are contemplated in any number of claim forms. Thus, the inventor reserves the right to add additional claims after filing the application to pursue such additional claim forms for other aspects of the present invention.

What is claimed is:

1. A nonwoven filter fabric composition, comprising:
at least one naturally-derived fiber; and
at least one thermoplastic polymer.

2. The composition of claim 1, wherein the at least one thermoplastic comprises polypropylene and a polyester.

3. The composition of claim 2, comprising:
55-68% polypropylene;
20-30% polyester; and
2-10% viscose fiber.

4. The composition of claim 2, comprising one or more of:
polypropylene up to 68% of the composition;
polyester up to 28% of the composition; and
viscose fiber up to 8% of the composition.

5. The composition of claim 2, wherein the polyester is polyethylene terephthalate.

6. The composition of claim 5, comprising:
55-68% polypropylene;
20-30% polyethylene terephthalate; and
2-10% viscous fiber.

7. The composition of claim 6, comprising one or more of:
polypropylene up to 68% of the composition;
polyethylene terephthalate up to 28% of the composition; and
viscose fiber up to 8% of the composition.

8. The composition of claim 1, wherein the at least one naturally-derived fiber is cellulose and the at least one thermoplastic polymer is polyethylene terephthalate.

9. The composition of claim 8, comprising:
85% cellulose; and
15% polyethylene terephthalate.

10. A method of using a nonwoven filter fabric composition, comprising:
providing a first filter fabric piece made in accordance with the composition of claim 3, wherein the first filter fabric has at least a first edge, a second edge, a first side and a second side;
folding the first filter fabric so as to overlay the first edge onto the second edge;
applying at least one reinforced seam to the first filter fabric, wherein the at least one reinforced seam is configured to transverse the filter fabric;
providing a cold brew filtering system having a cold brew filter basket and a cold brew filtering container;
inserting the first filter fabric into the filter basket;
filling the filtering container with a liquid;
inserting a substance suitable for steeping into the first filter fabric; and
steeping the substance suitable for steeping in the liquid.

11. The method of claim 10, wherein the at least one reinforced seam is a first reinforced seam and a second reinforced seam, and wherein the step of applying at least one reinforced seam to the first filter fabric comprises applying the first reinforced seam and the second reinforced seam to the first filter fabric, wherein the first reinforced seam and the second reinforced seam are configured to transverse the filter fabric.

12. The method of claim 10, wherein the at least one reinforced seam further comprises a third reinforced seam, and wherein the step of applying at least one reinforced seam to the first filter fabric further comprises applying a third reinforced seam configured to transverse the filter fabric.

13. A method of using a nonwoven filter fabric composition, comprising:
providing a first filter fabric piece made in accordance with the composition of claim 9, wherein the first filter fabric has at least a first edge, a second edge, a first side and a second side;
folding the first filter fabric so as to overlay the first edge onto the second edge;
applying at least one reinforced seam to the first filter fabric, wherein the at least one reinforced seam is configured to transverse the filter fabric;
providing a cold brew filtering system having a cold brew filter basket and a cold brew filtering container;
inserting the first filter fabric into the filter basket;
filling the filtering container with a liquid;
inserting a substance suitable for steeping into the first filter fabric; and
steeping the substance suitable for steeping in the liquid.

14. The method of claim 13, wherein the at least one reinforced seam is a first reinforced seam and a second reinforced seam, and wherein the step of applying at least one reinforced seam to the first filter fabric comprises applying the first reinforced seam and the second reinforced seam to the first filter fabric, wherein the first reinforced seam and the second reinforced seam are configured to transverse the filter fabric.

15. The method of claim 13, wherein the at least one reinforced seam further comprises a third reinforced seam, and wherein the step of applying at least one reinforced seam to the first filter fabric further comprises applying a third reinforced seam configured to transverse the filter fabric.
